(19) United States
(12) Patent Application Publication
(10) Pub. No.: US 2025/0365079 A1
(43) Pub. Date: Nov. 27, 2025

(54) SYSTEMS AND METHODS FOR HYBRID CV-DV QUANTUM COMMUNICATIONS AND QUANTUM NETWORKS

(71) Applicant: Arizona Board of Regents on Behalf of the University of Arizona, Tucson, AZ (US)

(72) Inventor: Ivan B. Djordjevic, Tucson, AZ (US)

(21) Appl. No.: 18/874,026

(22) PCT Filed: Jun. 15, 2023
(86) PCT No.: PCT/US23/68540

§ 371 Date: Dec. 11, 2024

Related U.S. Application Data
(60) Provisional application No. 63/352,540, filed on Jun. 15, 2022.

(51) Int. Cl. H04B 10/70

(52) U.S. Cl. CPC H04B 10/70

(57) ABSTRACT

A hybrid quantum communication network (QCN) can serve as the backbone for a future quantum Internet, thus providing extensive long-term impacts on the economy and national security through QIP, distributed quantum computing, quantum networking, and distributed quantum sensing. By employing photon addition and photon subtraction modules, the network can generate hybrid DV-CV entangled states and implement teleportation and entanglement swapping through entangling measurements. Transmission distance between nodes can be extended by employing macroscopic light states, noiseless amplification, and reconfigurable quantum LDPC coding.

### CROSS REFERENCE TO RELATED APPLICATIONS

The present document is a PCT patent application that claims benefit to U.S. Provisional Application Ser. No. 63/352,540, filed on Jun. 15, 2022, which is herein incorporated by reference in its entirety.

### FIELD

The present disclosure generally relates to quantum communications, and in particular, to a system and associated method for a hybrid CV-DV quantum network that enables distribution of a large number of entangled states in an arbitrary topology.

### BACKGROUND

Quantum information processing (QIP) opens new avenues for numerous applications, including high-performance computing, high-precision sensing, and secure communications. Among various QIP attributes, entanglement is a unique QIP feature and may be used to implement quantum computers capable of solving problems that are numerically intractable for classical computers. Entanglement-based approaches may also lead to quantum-enhanced sensors with measurement sensitivities that exceed classical limits, and may provide certifiable security for data transmission whose security is guaranteed by the laws of quantum mechanics—rather than the unproven assumptions used in cryptography based on computational security.

The distribution of entanglement over long distances has been an outstanding challenge due to photon losses (e.g., quantum signals cannot be amplified without introducing additional noise that degrades or even destroys the transmitted entanglement). Hence, quantum communication (e.g., QuCom) calls for fundamentally distinct loss-mitigation mechanisms to establish long-range entanglement. In this regard, quantum repeaters are being pursued (over the last decade) to overcome the exponentially low entanglement distribution rate versus transmission distance in optical fibers. Several technological challenges remain before developing fully functional quantum repeaters for long-distance QuCom, including the scalability of quantum devices, indistinguishability of emitted photons, and practical quantum error correction (QEC).

Some approaches utilize satellites as relays for QuCom over thousands of kilometers by virtue of the quadratic scaling of photon loss versus distance exhibited in free-space optical (FSO) links. However, while existing QuCom techniques may be individually validated over a specific type of quantum point-to-point link, a quantum communication network (QCN) that provides full integration of diverse QIP devices into a unified network remains undeveloped. In particular, the distribution of a large number of quantum states in multiaccess environment over various QCN topologies remains an open problem.

It is with these observations in mind, among others, that various aspects of the present disclosure were conceived and developed.

### SUMMARY

The present disclosure provides a number of examples that describe forming a hybrid CV-DV quantum network that enables distribution of a large number of entangled states in an arbitrary topology. In the context of the disclosed methods, devices, techniques, apparatus, systems, and so on, the terms “operable to,” “configured to,” and “capable of” used herein are interchangeable.

In a first set of illustrative examples, the techniques described herein are embodied by a method comprising: obtaining a first quantum state; obtaining a second quantum state; providing the first quantum state to a first single-photon addition module, wherein the first single-photon addition module generates as output a first idler state and a first photon addition signal state; providing the second quantum state to a second single-photon addition module, wherein the second single-photon addition module generates as output a second idler state and a second photon addition signal state; and mixing, using a beam splitter associated with a pair of outputs respectively connected to upper and lower branch single photon detectors (SPDs), an input including: a first idler photon associated with the first idler state generated by the first single-photon addition module; and a second idler photon associated with the second idler state generated by the second single-photon addition module.

In a second set of illustrative examples, an apparatus performs the disclosed operations; and in a third set of illustrative examples, a non-transitory, computer-readable medium stores instructions encoded thereon to perform the same operations.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a simplified diagram showing a hybrid DV-CV quantum communication network;

FIGS. 2A and 2B are simplified diagrams showing a single-photon addition module;

FIG. 3 is a simplified diagram showing a single-photon subtraction module;

FIG. 4 is a simplified diagram showing entanglement of two independent DV quantum states by delocalized photon addition;

FIG. 5 is a simplified diagram showing generation of an entangled hybrid DV-CV state by delocalized photon addition;

FIG. 6 is a simplified diagram showing entanglement swapping between a DV only node and a hybrid DV-CV node by two-photon subtraction;

FIG. 7 is a simplified diagram showing entanglement swapping and teleportation in which an intermediate node distributes the entanglement;

FIG. 8 is a simplified diagram showing generation of entangled photon-hole-embedded TSMV states;

FIG. 9 is a simplified diagram showing generation of macroscopic entangles CV-CV states;

FIG. 10 is a simplified diagram showing an extended distance between two nodes in a QCN by a reconfigurable QLDPC code;

FIG. 11 is a simplified diagram showing creation of a 9-node 2D cluster state from three linear cluster states using delocalized photon addition;

FIG. 12 is a simplified diagram showing generation of hybrid state suitable for use in entanglement-based hybrid QKD;

FIG. 13 is a graphical representation showing SKRs vs channel loss of various methods described herein against various existing protocols;

FIG. 14 is a graphical representation showing SKRs vs channel loss of various methods described herein against coherent state-based hybrid QKD;

FIG. 15 is a process flow diagram showing a method according to aspects of the present disclosure; and

FIG. 16 is a simplified diagram illustrating an example application of the presently disclosed hybrid CV-DV entanglement concepts enabling quantum Internet.

Corresponding reference characters indicate corresponding elements among the view of the drawings. The headings used in the figures do not limit the scope of the claims.

### DETAILED DESCRIPTION

### I. Introduction

To take advantage of quantum resources for quantum information processing (QIP), distributed quantum computing, quantum networking, and/or distributed quantum sensing, quantum systems can be interfaced based on different encodings of information (e.g., discrete or continuous encodings). For example, many current approaches for quantum computers use a discrete-variable (DV) encoding of information, while continuous-variable (CV) bosonic quantum systems are known to be more suitable for QCNs and future quantum Internet. Existing approaches to quantum computing often implement either a DV encoding of information or a CV encoding of information, but not both. Accordingly, there is a need for quantum computing approaches that can utilize DV and CV encodings of information. Disclosed herein are systems and techniques for hybrid DV-CV QCNs that can, for example, be used to provide the deterministic teleportation of DV states, as will be explained in greater depth below.

Even though entanglement distribution over point-to-point links has been demonstrated, the distribution of a large number of entangled states remains elusive. To this end, efficient and robust interfacing between CV and DV quantum nodes can be utilized to achieve the distribution of quantum states over transparent hybrid DV-CV multi-hop, multi-user networks with arbitrary network topology. As such, aspects of the present disclosure provide systems and methods for a hybrid CV-DV network that can be used to provide one or more connections of DV and CV optical quantum systems, which is a major step-forward to achieve optical quantum interconnects and networks.

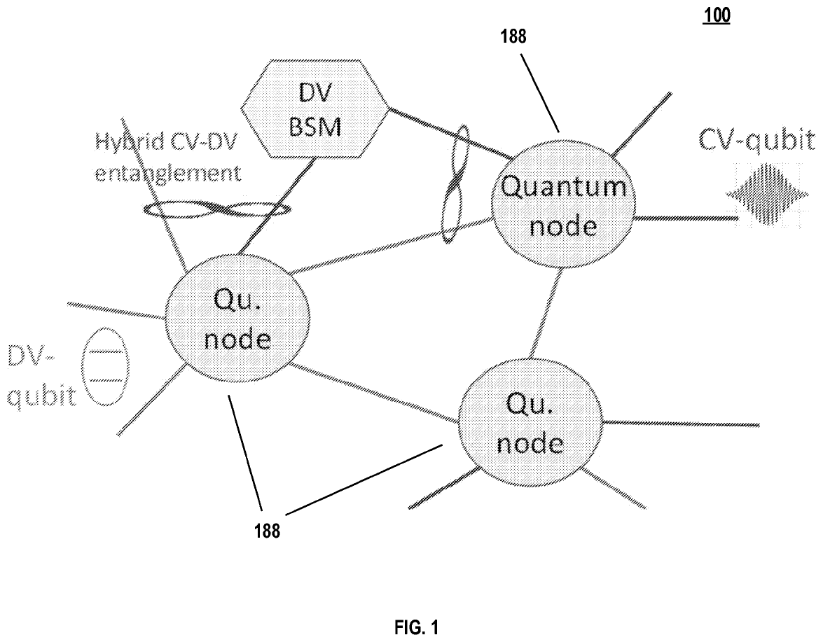

For example, FIG. 1 illustrates a hybrid CV-DV network 100, where the hybrid CV-DV network 100 includes a plurality of nodes, each node including a transmitter and a receiver that can generate DV, CV, and/or hybrid DV-CV entangled states according to various methods described herein. In some aspects, Bell-state measurements (BSMs) can be performed to apply teleportation and entanglement swapping operations for CV-to-DV and DV-to-CV information transfer and interconnection between the different types of nodes (e.g., CV nodes and DV nodes). In particular, the present disclosure provides efficient approaches to hybrid DV-CV entanglement generation, teleportation, and entanglement swapping by employing photon addition and photon subtraction modules.

Organization of the following description is provided below. Photon addition and photon subtraction modules are introduced in Sec. II. Sec. III describes how the generation of hybrid CV-DV entangled states by employing delocalized photon addition. Sec. IV describes the teleportation and entanglement swapping of hybrid states through entangling measurements. Sections V-VII describe techniques for extending a transmission distance between nodes in hybrid QCN, for example, by employing entangled macroscopic light states (Sec. V), noiseless amplification (Sec. VI), and/or reconfigurable quantum LDPC coding (Sec. VII). Sec. VIII describes an example implementation of cluster state-based networking and distributed computing based on photon addition. Sec. IX describes an example of entanglement-based hybrid Quantum key distribution (QKD). Finally, Sec. X provides concluding remarks.

### II. Photon Addition and Photon Subtraction Modules

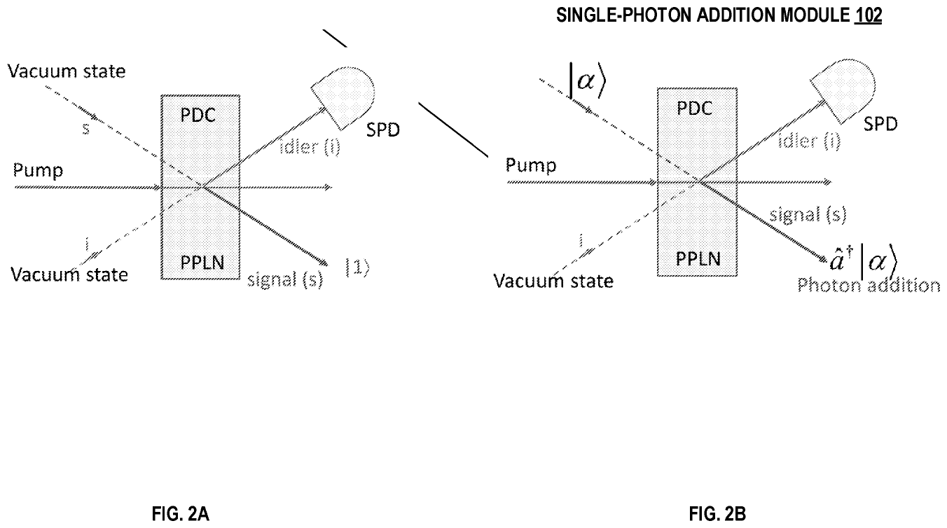

Photon addition can be based on parametric down conversion (PDC), as illustrated in FIGS. 2A and 2B. FIG. 2A shows an example of heralded generation of single-photon states, and FIG. 2B illustrates an example single-photon addition module 102 of the hybrid CV-DV network 100. By replacing the vacuum state in the input signal port with a coherent state |a [symbol] (e.g., replacing the vacuum state s depicted in the input signal port of FIG. 2A with the coherent state |a≤ as shown in FIG. 2B), the single-photon addition module 102 adds a single photon to the coherent state to get a^{†}|α [symbol] , where a^{†} is the creation operator. In some examples, the input to the single-photon addition module can be a first quantum state or a second quantum state, as will be described in greater depth below. Upon removal of a single-photon detector from FIG. 2A, a common entanglement source can be obtained, thereby generating the two-mode squeezed vacuum (TMSV) states. The TMSV state has the following representation in the Fock basis:

$${{{\vert ψ 〉}_{s , i} = {( {N}_{s} + 1 )}^{- 1 / 2} {{\sum }_{n = 0}^{∞} [ {N}_{s} / ( {N}_{s} + 1 ) ]}^{n / 2} \vert n 〉}_{s} \vert n 〉}_{i} , \qquad ( 1 )$$

with the mean photon number being Nₛ= [symbol] âₛ^{†}âₛ [symbol] = [symbol] âᵢ^{†}âᵢ [symbol] , with corresponding signal and idler annihilation operators denoted by âₛ and âᵢ, respectively. Each respective single-photon addition module 102 receives a respective quantum state as input and generates as output an idler state and a photon addition signal state.

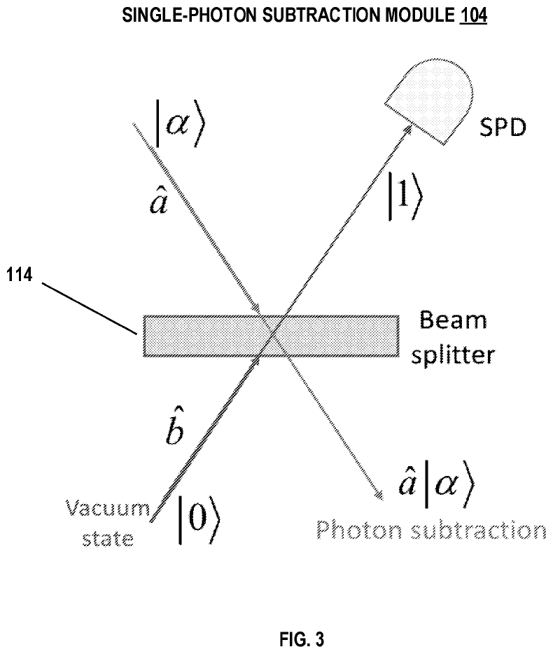

A single-photon subtraction module 104 of the hybrid CV-DV network 100 is illustrated in FIG. 3 and can utilize a beam splitter to perform a single-photon subtraction operation. The operation of the beam splitter can be described by the unitary transformation Û=exp[jθ(â^{†}\hat{b}+â\hat{b}^{†})]. For small θ, the action on an input state |α [symbol] |0 [symbol] will be:

$$\begin{matrix}{\vert ψ 〉}_{o u t} = exp [ j θ ( {\hat{a}}^{†} \hat{b} + \hat{a} {\hat{b}}^{†} ) ] \vert α 〉 \vert 0 〉 \\ ≅ \vert α 〉 \vert 0 〉 + j θ ( {\hat{a}}^{†} \hat{b} + \hat{a} {\hat{b}}^{†} ) \vert α 〉 \vert 0 〉 \\ = \vert α 〉 \vert 0 〉 + j θ ( \hat{a} ⌊ \hat{a} 〉 ) \vert 1 〉 .\end{matrix} \qquad ( 2 )$$

Each respective single-photon subtraction module 104 receives a respective quantum state as input and generates as output a subtracted photon and a single photon state.

Detection of a photon by a single photon detector (SPD) associated with a first (e.g., upper) output port of the single-photon subtraction module 104 heralds the single-photon subtraction at a second output port of the single-photon subtraction module 104 (e.g., wherein the example SPD 104 illustrated in FIG. 3 includes two output ports). In one illustrative example, photon addition and/or photon subtraction modules can be utilized to implement two entanglement engineering operations to create hybrid CV-DV entangled states, teleportation, and entanglement swapping.

### III. Generation of Hybrid DV-CV Entangled States by Delocalized Photon Addition

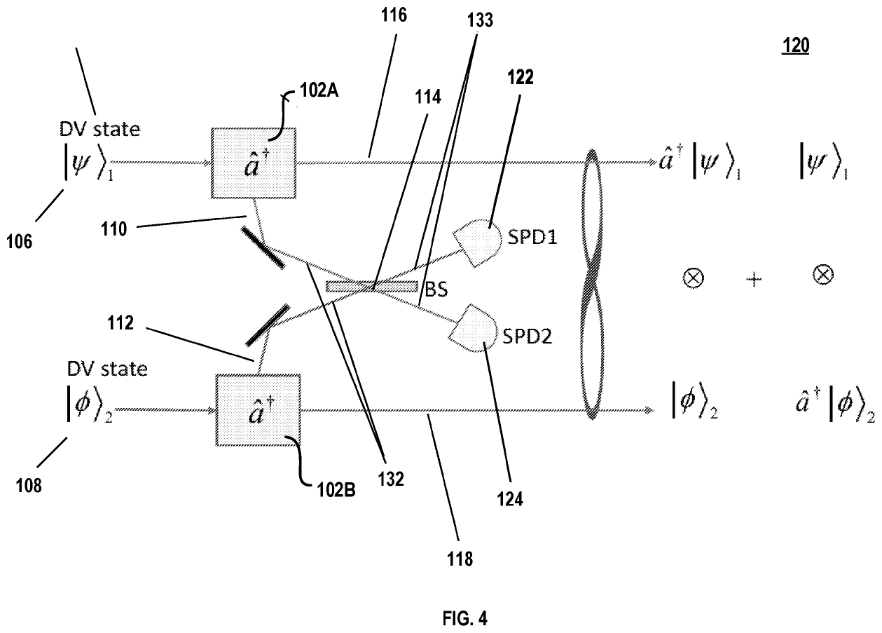

FIG. 4 shows a DV-DV entanglement module 120 of the hybrid CV-DV network 100 that uses a first single-photon addition module 102A and a second single-photon addition module 102B to entangle two independent DV quantum states, shown here as a first quantum state 106 (e.g., the input DV state |ψ [symbol] ₁) and a second quantum state 108 (e.g., the input DV state |ϕ [symbol] ₂). The first quantum state 106 is input (132) to the first single-photon addition module 102A, which generates as output a first idler state 110 and a first photon addition signal state (116). Similarly, the second quantum state 108 is input to the second single-photon addition module 102B, which generates as output a second idler state 112 and a second photon addition signal state (118). The first idler photon (e.g., associated with the first idler state generated by the first single-photon addition module) and a second idler photon (e.g., associated with the second idler state generated by the second single-photon addition module) can then be mixed at a beam splitter (114), where outputs of the beam splitter are connected to an upper branch single photon detector (122) SPD1 and a lower branch single photon detector (124) SPD2. When a photon gets detected at the upper branch single photon detector SPD1 (or the lower branch single photon detector SPD2), it is unknown if the detected photon originated from the upper or lower photon addition module. This inability to distinguish between two possibilities will indicate that the following quantum state:

$${\vert Ψ 〉}_{o u t} = {2}^{- 1 / 2} [ ( {\hat{a}}^{†} \vert ψ 〉 ) ⌊ ϕ 〉 + \vert ψ 〉 ( {\hat{a}}^{†} \vert ϕ 〉 ) ] \qquad ( 3 )$$

is entangled.

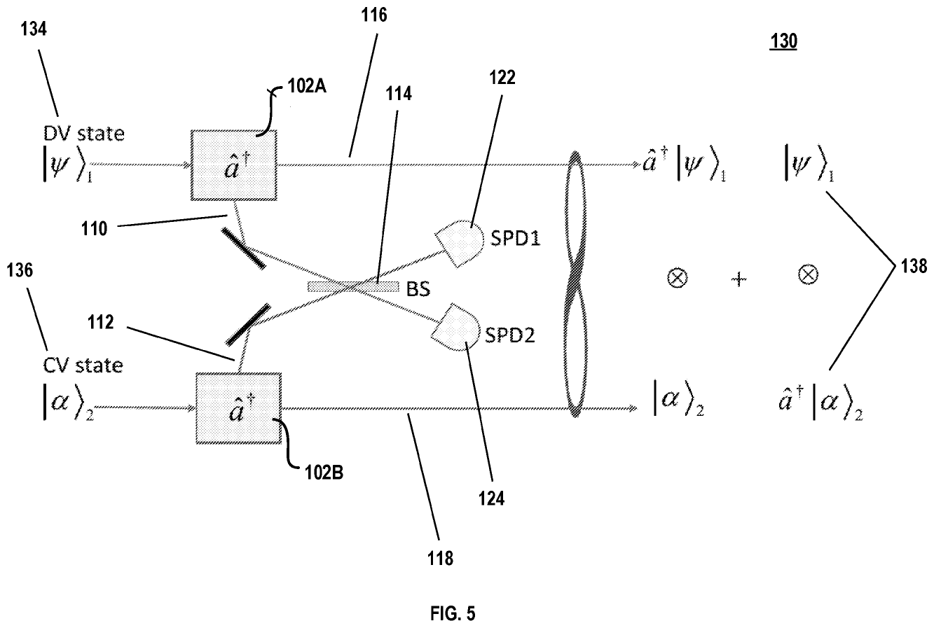

FIG. 5 shows a DV-CV entanglement module 130 of the hybrid CV-DV network 100 that uses the first single-photon addition module 102A and the second single-photon addition module 102B in a similar manner to FIG. 4 but replaces the input DV state |ϕ [symbol] ₂ (e.g., the second quantum state) in FIG. 4 with the CV state |α [symbol] ₂. As such, the DV-CV entanglement module 130 can generate a hybrid DV-CV state as illustrated in FIG. 5. Similar to as was described previously with respect to FIG. 4, upon detection of the photon at the upper branch single photon detector SPD1 (or the lower branch single photon detector SPD2) it is unknown if the detected photon originated from the first single-photon addition module 102A or the second single-photon addition module 102B. This inability to distinguish between two possibilities will indicate that the following hybrid DV-CV state:

$${\vert Ψ 〉}_{out} = {2}^{- 1 / 2} [ ( {\hat{a}}^{†} \vert ψ 〉 ) ⌊ a 〉 + \vert ψ 〉 ( {\hat{a}}^{†} \vert a 〉 ) ] \qquad ( 4 )$$

is entangled.

The photon addition described herein can also apply to multipartite entangled states (e.g., a first multipartite state and a second multipartite state). Assume that the two input states to the quantum circuit in FIG. 4 are multipartite with M and N qubits, respectively. By performing the delocalized photon addition on the M^{th} qubit (e.g., the last qubit) from the top multipartite state and on the first qubit on the bottom multipartite state, once the photons are simultaneously detected on the upper branch single photon detector SPD1 (or the lower branch single photon detector SPD2), one can effectively herald the multipartite state with (M+N) qubits.

### IV. Hybrid CV-DV States Teleportation and Entanglement Swapping Through Entangling Measurements

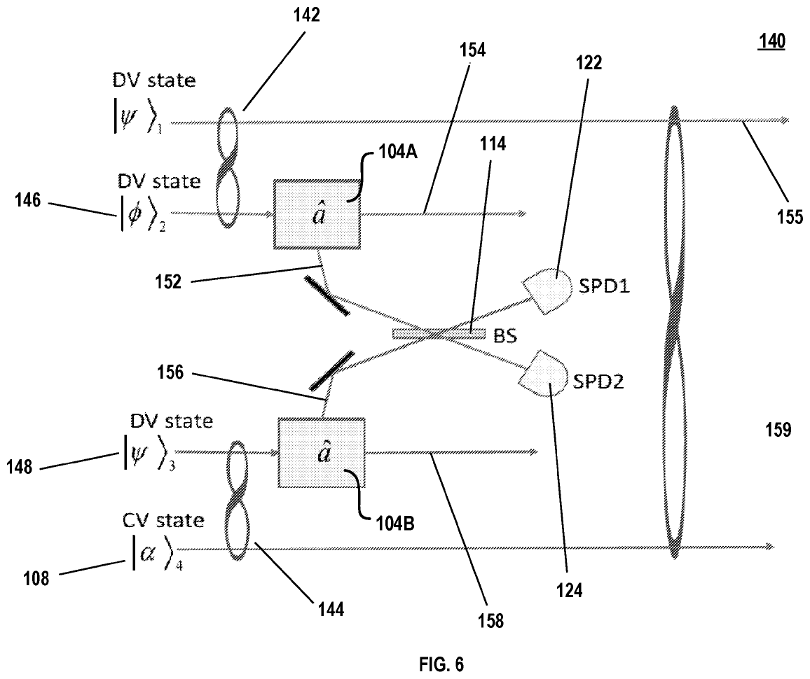

FIG. 6 shows an entanglement swapping module 140 of the hybrid CV-DV network 100 that can be used to perform entanglement swapping between DV only nodes (e.g., DV-DV entanglement swapping) and/or between hybrid DV-CV nodes (e.g., DV-CV entanglement swapping) using a first photon subtraction module 104A and a second photon subtraction module 104B that collectively apply a two-photon subtraction approach shown in FIG. 6. When the upper branch single photon detector SPD1 (or the lower branch single photon detector SPD2) detects a photon, it is unknown whether the signal originates from a photon subtracted from a DV state |ϕ [symbol] ₂ (e.g., a first quantum state) or a DV state |ψ [symbol] ₃ (e.g., a second quantum state), and this uncertainty entangles DV state |ψ [symbol] ₁ and CV state |α [symbol] ₄, effectively performing entanglement swapping.

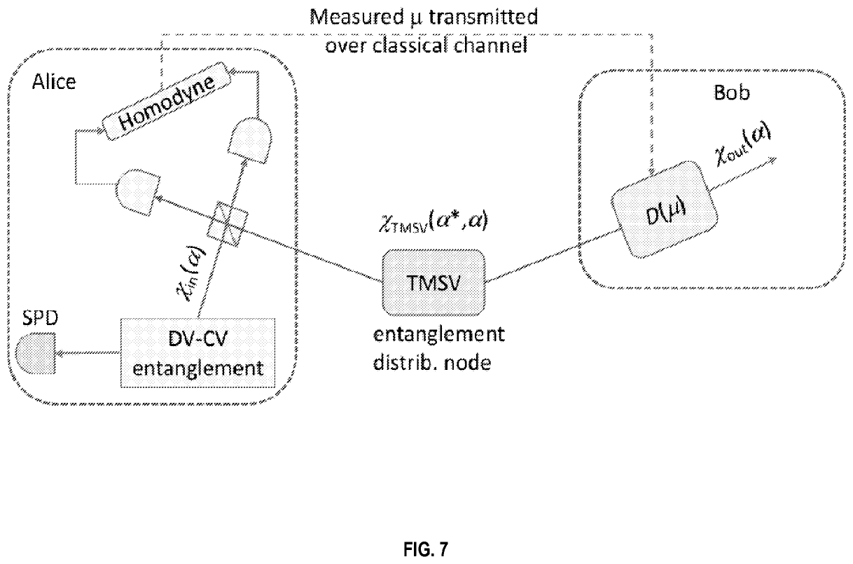

The entanglement swapping and teleportation can be implemented as illustrated in FIG. 7, in which an intermediate node distributes the entanglement. In one example scenario, Bob possesses a CV state, while Alice possesses a hybrid DV-CV state. Alice mixes her CV mode (from the hybrid state) with the TMSV mode on beam splitter. To characterize this input, one can use the characteristic function, defined as Xᵢₙ(α)= [symbol] D(α)), where D(α) is the displacement operator. X_{TMSV}(α*, α)=exp [−|α|² exp(−2r)] can determine the TMSV state characteristic function, where r is the squeezing parameter. Alice performs the homodyne detection on beam splitter outputs to obtain μ and transmits μ over a classical channel to Bob, who uses μ to perform the displacement operator D(μ) on his qubit from the TMSV pair. Bob's Characteristic function is given by Xₒᵤₜ(α)=Xᵢₙ(α)X_{TMSV}(α*, α). Clearly, only when r→∞ will Bob be able to perfectly recover Alice's transmitted state, since then X_{TMSV}(α*, α)→1.

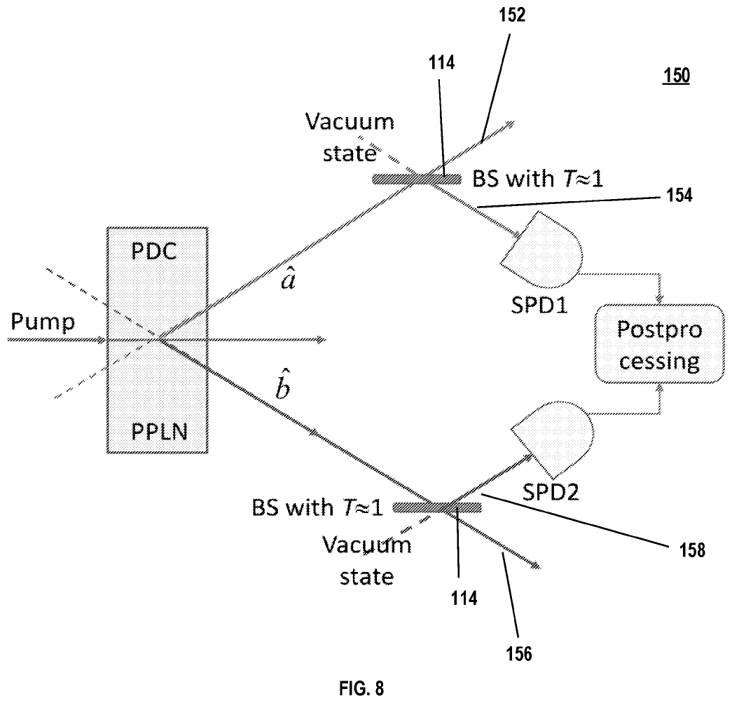

The Schrödinger's cat states can be used to represent the CV qubits as follows: |ψ_{CV} [symbol] =N_{±}(|α [symbol] ±|−α [symbol] ), where N_{±} is the normalization factor. The cat states are typically obtained as the approximation of single-mode squeezed vacuum states for properly chosen squeezing parameter r, such as r=0.18. Unfortunately, such generated cat states are not very tolerant to loss. On the other hand, entangled-photon holes exhibit good tolerance to loss and amplification that can be generated at an entangled-photon hole module 150 of the hybrid CV-DV network 100 shown in FIG. 8.

Two-photon subtraction can be represented by |ψ [symbol] =â\hat{b}S₂(z)|0,0 [symbol] , where S₂(z) is the two-mode squeezing operator

$${S}_{2} ( z ) = {e}^{z {\hat{a}}^{†} {\hat{b}}^{†} - {z}^{*} \hat{α} \hat{b}}$$

with z=r exp(jθ). Upon introduction of a new basis â₊=2^{-1/2}(â+\hat{b}), â−=2^{-1/2}(â−\hat{b}), the two-mode squeezing operator S₂(z) can be represented as a product of two single-mode squeezing operators S_{±}(±z). Now, a two-photon subtracted state can be represented in a form similar to the cat state:

$$\vert ψ 〉 = ( {\hat{a}}_{+}^{2} {S}_{+} \vert 0 〉 ) ( {S}_{-} \vert 0 〉 ) - ( {S}_{+} \vert 0 〉 ) ( {\hat{a}}_{-}^{2} {S}_{-} \vert 0 〉 ) , \qquad ( 5 )$$

but does not require the squeezing parameter to be low.

### V. Extending the Transmission Distance Between Quantum Nodes by Employing the Entangled Macroscopic Light States

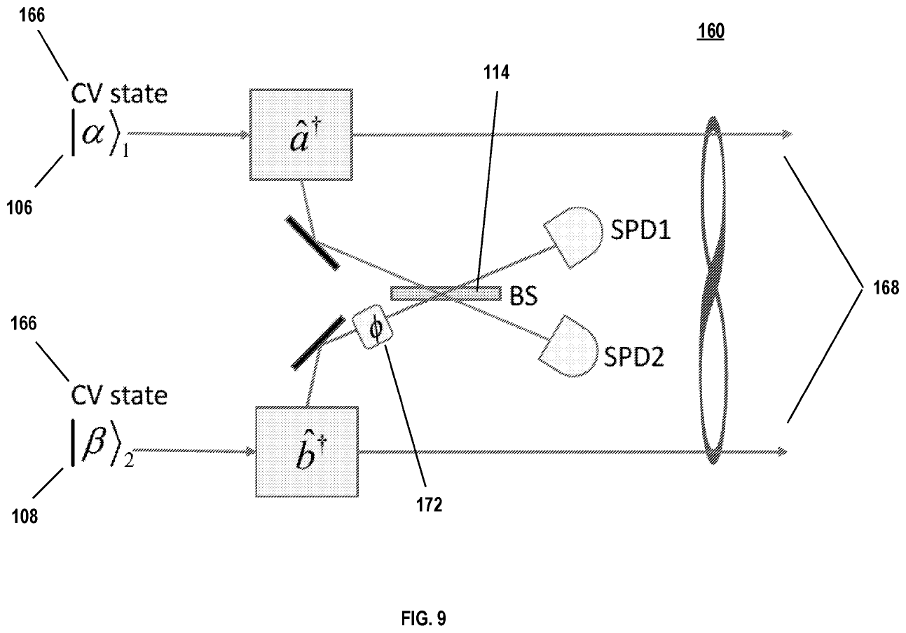

To extend the transmission distance between the quantum nodes, a CV-CV macroscopic state generation module 160 of the hybrid CV-DV network 100 can use macroscopic light states as CV states, based on recent findings that macroscopic light states can be entangled. The corresponding CV-CV macroscopic state generation module 160 to generate entangled CV-CV macroscopic states (168) is shown in FIG. 9. The output state can be represented by:

$${{{{\vert ψ 〉 = {- 1 / 2}^{} ( {\hat{a}}^{†} \vert α 〉}_{1} \vert β 〉}_{2} + {e}^{j ϕ} \vert a 〉}_{1} {\hat{b}}^{†} \vert β 〉}_{2} ) , \qquad ( 6 )$$

where [symbol] is the normalization factor. The phase shift needs to be properly chosen to ensure that the output macroscopic states are entangled. Now, by using the following property of the displacement operator â^{†}D(α)=D(α)(â†+α*), the output states can be represented as follows:

$$( 7 )$$

$$\vert ψ 〉 = {- 1 / 2}^{} {D}_{1} ( a ) {D}_{2} ( β ) ( \vert 1 〉 \vert 0 〉 + {e}^{j ϕ} \vert 0 〉 \vert 1 〉 ) + {- 1 / 2}^{} a ⋆ ( 1 + {e}^{j ϕ} ) \vert a 〉 \vert β 〉 .$$

Here, the first state is an entangled state, while the second state is a separable state. Now, by setting ϕ=π, the second term becomes zero and the CV-CV macroscopic state generation module 160 shown in FIG. 9 can indeed entangle the macroscopic CV states that are tolerant to losses. This approach allows the distances between nodes to significantly increase.

### VI. Extending the Transmission Distance Between Quantum Nodes by Noiseless Amplification

To extend the transmission distance between quantum nodes in hybrid CV-DV networks, noiseless amplification can be applied. The amplification process can typically be represented by:

$$a \to b \sqrt{G a} + n ; 〈 n 〉 = 0 , 〈 {n}^{†} n 〉 \neq 0 \qquad ( 8 )$$

where b is the amplifier output mode, G is the amplifier gain, while n is the noise mode. Here, the signal-to-noise ratio (SNR) can deteriorate since:

$$〈 {b}^{†} b 〉 = {Ga}^{†} a + \sqrt{G} ( {a}^{†} n + {n}^{†} a ) + {n}^{†} n , \qquad ( 9 )$$

indicating the amplified mode can be affected by signal-noise and noise terms.

To solve for this problem, a heralded photon amplifier can be implemented in which the photon addition is followed by the photon subtraction such that the input state, represented by the density operator ρ, can map to:

$$ρ \to a ( {a}^{†} ρ a ) {a}^{†} \qquad ( 10 )$$

When the input of the noiseless amplifier is in superposition state ρ=α|0 [symbol] [symbol] 0|+β|1 [symbol] [symbol] 1|, the input state gets mapped to:

$$ρ \to 2 β \vert 1 〉 〈 1 \vert \qquad ( 11 )$$

indicating that the single photon state acquires the gain of 2 and the noise is not added.

### VII. Extending the Transmission Distance Between Quantum Nodes by Reconfigurable Quantum LDPC (QLDPC) Coding

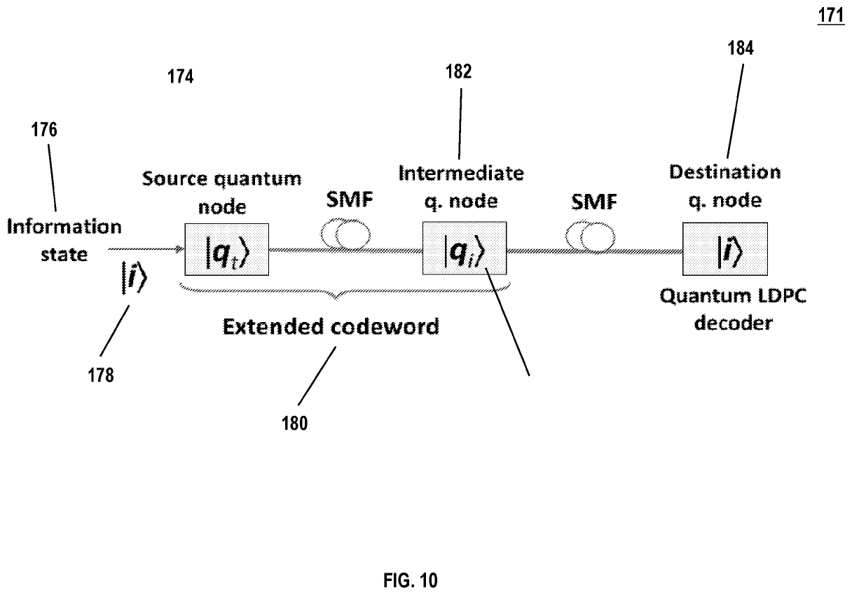

With reference to FIG. 10, to extend the transmission distance between nodes, the systems and techniques described herein can be used to perform QEC-based quantum networking that employs QLDPC coding, where the corresponding QLDPC code can include multiple subcodes. An information state of K qubits is encoded by a systematic [N, K] QLDPC code to obtain the codeword |qₜ [symbol] . Intermediate quantum-node simple syndrome decoding identifies the most probable quantum-error operator and corrects it. After that, the re-encoding takes place by inserting additional redundant qubits. Therefore, the method can progressively improve the error correction strength based on the number of intermediate nodes. The QLDPC soft-decision decoding takes place at the destination node.

### VIII. Hybrid DV-CV Quantum Networking Based on Cluster State Concept

A cluster state-based quantum networking concept is summarized in this section of the present disclosure. When a cluster C is defined as a connected subset on a d-dimensional lattice, it obeys the set of eigenvalue equations Sₐ|ϕ [symbol] _{C}=|ϕ [symbol] _{C}, where Sₐ=Xₐ⊗_{b∈N(a)}Z_{b} are stabilizer operators with N(a) denoting the neighborhood of a∈C. To create a 2-D cluster state, linear states (e.g., generated by spontaneous PDC, local unitaries, and type I fusion, etc.) can be used to create the desired 2-D cluster state. The type I fusion can include a polarization beam splitter (PBS), 45° polarization rotator, and the SPD. The PBS reflects the vertical photon, while the horizontal photon gets transmitted through the PBS. Given the probabilistic nature of the PBS, when photons are present at both input ports, there exist four possible outcomes each occurring with a probability of 0.25. Two outcomes correspond to the desired fusion operators, and the success probability of the fusion is 0.5. When a single photon is detected by the detector, the successful fusion is declared. When the fusion process is not successful, the procedure should be repeated. Therefore, building the quantum network by employing the fusion process could be both time and resource consuming.

To solve for this problem, the photon addition concept introduced in FIGS. 4 and 5 can be employed, wherein the quantum states to be entangled are now the cluster states. An advantage of photon addition over type I fusion is that with photon addition, the creation of a desired cluster state becomes the deterministic process. Another advantage of the photon addition is that the qubits in the cluster do not have to be DV or CV only. Namely, photon addition to create a desired cluster state can be applied to all possible types of qubits, including DV, CV, and hybrid DV-CV.

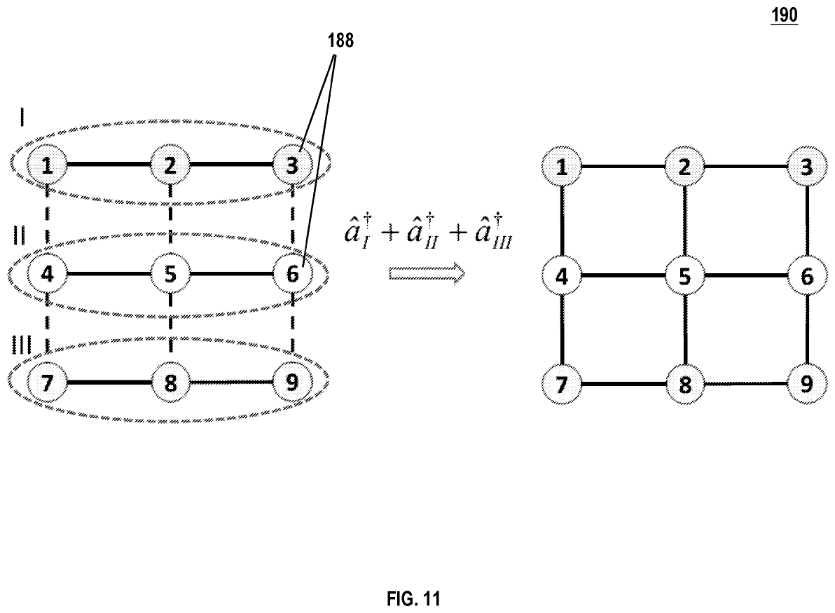

Upon creation of a 2-D cluster state of DV nodes, where the qubits locate at different nodes in the QCN, the set of measurements can be performed on a properly selected set of nodes to establish the EPR pairs (e.g., Bell states) between an arbitrary two nodes (e.g., a first QCN node and a second QCN node) in the QCN. Because the 2-D DV cluster state is universal, the same 2-D network architecture can be utilized for both the QCN and distributed quantum computing. In one example, FIG. 11 illustrates a 2-D cluster state that may be created with 9 nodes, starting from three linear cluster states. The dashed lines indicate that the physical links are installed but corresponding nodes are not entangled. By performing the delocalized photon addition between nodes 3-6 and 6-9, the three linear cluster states can be entangled to effectively create the 2-D 9-node cluster state. This cluster state is suitable for distributed quantum computing. To establish EPR pairs between any two nodes, the systems and techniques described herein can operate over properly selected Y and Z measurements. Note that if the method is not necessarily applied to distributed quantum computing or sensing but is only applied to quantum networking, then the cluster state concept can be optional because the method can create an arbitrary quantum network topology by performing delocalized photon additions on properly chosen nodes in the network.

### IX. Hybrid CV-DV QKD Networks

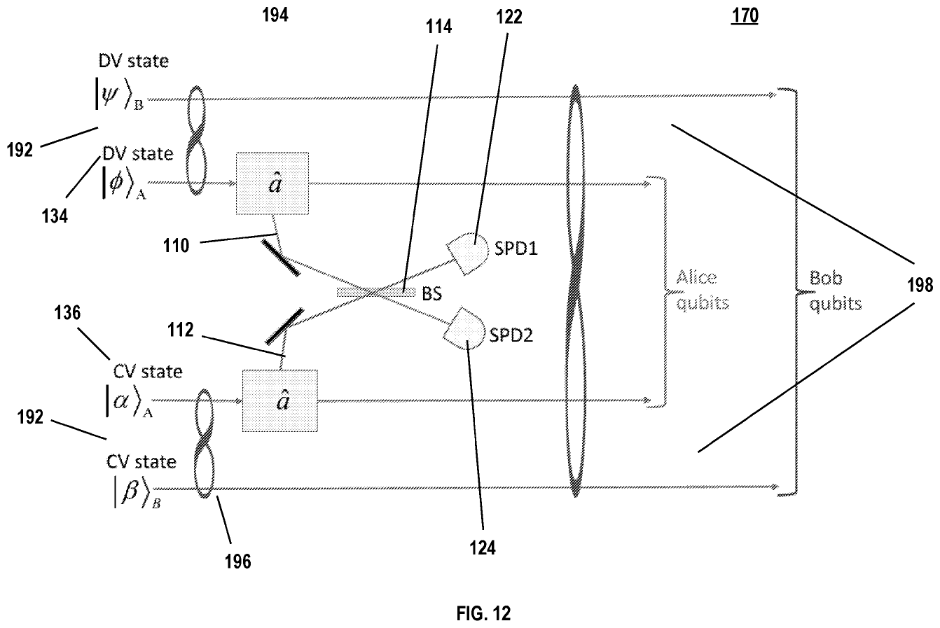

In a hybrid CV-DV QKD module 170 of the hybrid CV-DV network 100 shown in FIG. 12, both DV and CV degrees of freedom are encoded on the same quantum state. In one illustrative example, with the help of an optical switch Bob randomly selects a DV or CV receiver and shares this information with Alice. Alice and Bob then perform sifting procedures on both CV and DV subsystems. The information reconciliation is further applied on CV and DV raw keys so that the corrected key corresponding to hybrid scheme is obtained, followed by privacy amplification to obtain the secure key. The hybrid QKD discussed herein is based on entangled hybrid states obtained by the localized photon addition concept introduced in FIGS. 4 and 5. In this protocol, Alice simultaneously encodes her CV and DV qubits and Bob simultaneously measures his CV and DV qubits by randomly selected DV and CV basis. This protocol can be implemented as a generalization of both CV and DV protocols. Given that this entanglement-based (EB) hybrid QKD scheme does not require the use of an optical switch, higher SKRs can be obtained compared to in a coherent state-based hybrid QKD scheme. There are different options how such entangled states, suitable for hybrid QKD, can be obtained. For instance, one can first create separate entangled DV-DV and CV-CV states and entangle them further by another photon addition stage, which is illustrated in FIG. 12. In some examples, the same pump laser or pump diode can be used for one or more (or all) of the photon addition modules, with the help of a power splitter.

In another illustrative example, Alice can start with two independent coherent states |α [symbol] _{A} and DV state |ϕ [symbol] _{A}, encode them separately, and use them at the input of photon addition module. At the same time, she can prepare two independent coherent state |β [symbol] _{b}; and DV state |ψ [symbol] _{A} for Bob and entangle them in another photon addition module. In the second photon addition stage, she can further entangle her and Bob's hybrid states. On receiver side, Bob can perform simultaneous measurements on his CV and DV qubits and recover the transmitted sequences from Alice, provided that he used the same DV basis and CV basis that Alice used. Therefore, this version of EB hybrid QKD protocol is a generalization of an optimized-eight-state CV-QKD protocol, and the corresponding secret-key rate (SKR) expression is similar.

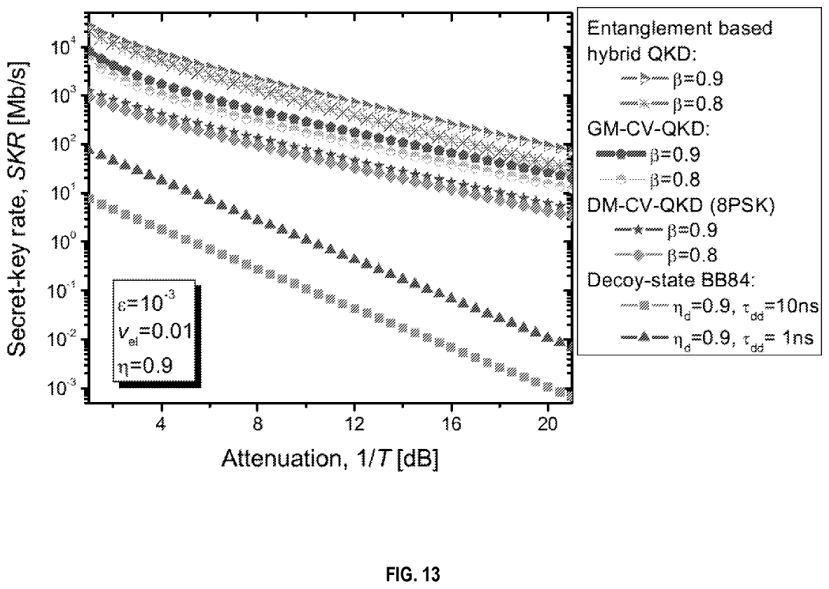

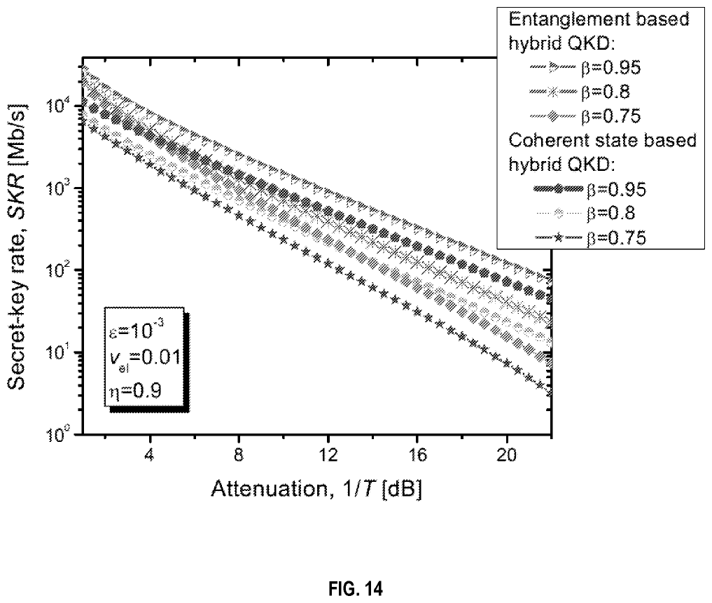

To illustrate the advantages of the proposed EB hybrid scheme against a conventional decoy-state BB84, Gaussian modulation (GM) based CV-QKD, and discrete modulation (DM) based CV-QKD with 8PSK protocols, the decoy-state BB84 with time-phase encoding protocol is applied on DV state and DM-CV-QKD protocol is applied on CV state before entangling them as described above. The DM-CV-QKD protocol is based on 8-star-QAM. The SKR results are summarized in FIG. 13. The CV-QKD subsystem parameters are selected as follows: the excess noise variance is ε=10⁻³, electrical noise variance is set to vₑₗ=0.01, and detector efficiency is η=0.9. The ratio of outer circle (containing four points) and inner circle (containing other four points) radii in 8-star-QAM is 1.35. On the other hand, the decoy-state BB84 subsystem parameters are selected as: dark current rate p_{d}=10⁻⁶, the detection efficiency η_{d}=0.9, the dead time of SPDs is τ_{dd}=10 ns, the error correction (in)efficiency is ƒₑ=1.1, and the intrinsic misalignment error rate is 0.005. From the results in FIG. 13, it can be seen that the EB hybrid QKD scheme, described above, outperforms both GM-CV-QKD and DM-CV-QKD (with 8PSK) QKD schemes for all channel losses and both reconciliation efficiencies B=0.9 and B=0.8 (under study). The EB hybrid QKD scheme significantly outperforms the decoy-state BB84 protocol. On the other hand, FIG. 14 shows a comparison of the EB hybrid QKD against a corresponding coherent state-based hybrid QKD scheme for MEMS-based optical switch of insertion loss of 2 dB. Here, the SKRs for the EB hybrid QKD scheme are higher than SKRs for coherent state-based hybrid QKD scheme for all three reconciliation efficiencies considered (e.g., B=0.95, 0.8, and 0.75). As the channel loss increases, the gap between corresponding curves is getting more pronounced. Therefore, the EB hybrid QKD scheme represents a promising candidate to increase the SKR. Moreover, by employing the photon addition concept the EB hybrid QKD scheme can be extended to the multipartite DV and CV states and overall SKRs can be further improved. Alternatively, for fixed SKR, the transmission distance between neighboring nodes in the QKD network can be extended.

### X. Conclusion

The present disclosure provides groundwork for development of a robust and efficient hybrid CV-DV quantum network enabling distribution of a large number of entangled states over hybrid DV-CV multi-hop nodes in an arbitrary topology. The hybrid CV-DV QCN can serve as the backbone for the future quantum Internet.

A system and associated methods described herein (e.g., “systems and techniques”) can employ the photon addition and photon subtraction modules described herein to generate entangled CV-DV states. Further, the systems and techniques can enable teleportation and entanglement swapping of hybrid states by using the entangling measurements. To extend the transmission distance between nodes in hybrid QCN, the systems and techniques can employ entangled macroscopic states, noiseless amplification, and/or reconfigurable QLDPC coding. To simultaneously perform quantum networking and distributed quantum computing, the systems and techniques described herein can use a deterministic cluster state concept based on the use of one or more photon addition modules. Finally, the present disclosure demonstrates that the EB hybrid QKD concepts outperform existing QKD schemes suitable for use in future hybrid QKD networks.

### XI. Methods

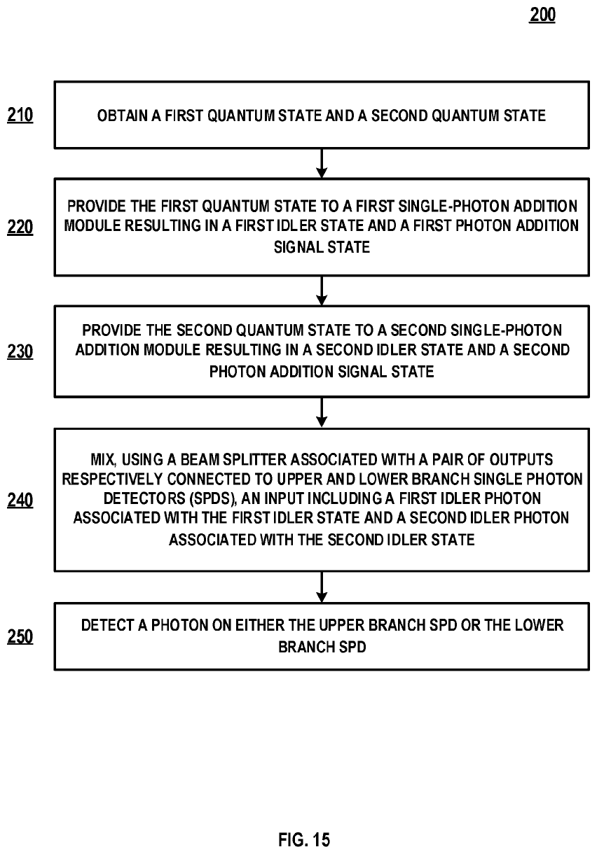

FIG. 15 illustrates a method 200 outlining various concepts outlined above, with additional reference to FIGS. 2B-5 and sections Il and III of the present disclosure. In particular, method 200 implements aspects of the hybrid CV-DV network 100 shown in FIG. 1 and/or various modules described herein and shown in FIGS. 2B-12. Block 210 of method 200 shows obtaining a first quantum state and a second quantum state. Block 220 of method 200 shows providing the first quantum state to a first single-photon addition module resulting in a first idler state and a first photon addition signal state. Block 230 of method 200 shows providing the second quantum state to a second single-photon addition module resulting in a second idler state and a second photon addition signal state. Block 240 of method 200 shows mixing, using a beam splitter associated with a pair of outputs (133) respectively connected to upper and lower branch single photon detectors (SPDs), an input including a first idler photon associated with the first idler state and a second idler photon associated with the second idler state. Block 250 of method 200 shows detecting a photon on either the upper branch SPD or the lower branch SPD, where the first quantum state and the second quantum state are entangled based on an uncertainty associated with the detected photon being associated with either the first idler state or the second idler state. The first and second single photon-addition modules, with the exception of the upper branch SPD, the lower branch SPD and a pump diode, can be integrated on a same chip.

In some embodiments, the first quantum state and the second quantum state include one or more of a discrete-variable (DV) quantum state, a continuous-variable (CV) quantum state, a hybrid CV-DV entangled quantum state (138), or a macroscopic quantum state. Further, the first quantum state can be independent from the second quantum state. The first quantum state and the second quantum state can each respectively be a first multipartite quantum state and a second multipartite quantum state, with a last qubit of the first multipartite state being provided to the first single-photon addition module and a first qubit of the second multipartite state being provided to the second single-photon addition module. With reference to FIG. 11, the first and second quantum states can both be obtained cluster states associated with nodes of a Quantum Communication Network (QCN) (171), where the QCN includes a plurality of nodes arranged in a 2D cluster state. The plurality of nodes arranged in the 2D cluster state of the QCN can be entangled based on performing delocalized photon addition between one or more pairs of nodes.

In a further aspect, with continued reference to FIGS. 2B-5 and sections II and III of the present disclosure, the first multipartite state and the second multipartite state can be entangled by interacting the first and second idler photons on the beam splitter, where detection of a photon on either the upper branch SPD or the lower branch SPD indicates that the multipartite states are entangled.

In some embodiments, referring to FIGS. 6-8 and section IV of the present disclosure, the method includes performing entanglement swapping between a first entangled pair (142) and a second entangled pair (144), where the first quantum state is included in the first entangled pair and the second quantum state is included in the second entangled pair. This can include entangling an additional quantum state included in the first entangled pair (146) with an additional quantum state included in the second entangled pair (148), based on interacting the first and second idler photons on the beam splitter, where the detection of a photon on either the upper branch SPD or the lower branch SPD indicates that the first entangled pair is entangled with the second entangled pair.

Further, the method can include the steps of: providing a discrete-variable (DV) quantum state of an entangled DV-DV quantum state pair to a first photon-subtraction module, where the first photon-subtraction module generates as output a first subtracted photon (152) and a first single photon state (154); providing a DV quantum state of a hybrid entangled continuous variable-discrete variable (CV-DV) quantum state pair to a second photon-subtraction module, where the second photon-subtraction module generates as output a second subtracted photon (156) and a second single photon state (158); mixing, using an additional beam splitter having a pair of outputs respectively connected to additional upper and lower branch SPDs, the first single photon state generated by the first photon-subtraction module and the second single photon state generated by the second photon-subtraction module; and detecting a photon on either the additional upper branch SPD or the additional lower branch SPD, where the remaining DV quantum state (155) of the DV-DV quantum state pair is entangled with the CV quantum state of the hybrid CV-DV quantum state pair based on an uncertainty in the detected photon being associated with either the first single photon state or the second single photon state.

In a further aspect, with reference to FIG. 9 and section V of the present disclosure, the first quantum state and the second quantum state can both include macroscopic continuous variable (CV) light states (166), which can be mixed using the beam splitter to generate an entangled CV-CV macroscopic state. This can involve applying a phase shift (172) to either the beam splitter input of the first idler photon or the beam splitter input of the second idler photon, the phase shift being selected such that the output macroscopic CV states are entangled.

In some embodiments, with reference to section VI of the present disclosure, the method can include performing noiseless amplification by providing an arbitrary state as input to a photon amplifier, where the photon amplifier includes a photon addition stage coupled to a photon subtraction stage and an output of the photon addition stage is coupled to an input of the photon subtraction stage, and where the input state to the photon amplifier is provided in a superposition state that causes the photon amplifier to apply a noise-free gain.

In another aspect, with reference to FIG. 10 and section VII of the present disclosure, the method can include the steps of: obtaining, at a first node of a Quantum Communication Network (QCN), an input quantum information state comprising one or more qubits; generating, by the first QCN node, a quantum low-density parity-check (QLDPC) codeword based on the input quantum information state, where the first QCN node generates the QLDPC codeword by encoding the input quantum information state using a QLDPC code; and transmitting the QLDPC codeword from the first QCN node to an intermediate QCN node, where the first and second QCN nodes are included in a Quantum Error Correction (QEC)-based QCN. This can further involve steps including: receiving, at the intermediate QCN node, the QLDPC codeword transmitted from the first QCN node; correcting, at the intermediate QCN node, a most probable quantum error operator identified by the intermediate QCN node; and re-encoding, at the intermediate QCN node, an error-corrected QLDPC codeword, where the intermediate QCN node inserts one or more additional redundant qubits in the re-encoded QLDPC codeword. Soft-decision decoding can then be performed at a final QCN node of the QCN.

Further, with reference to FIG. 12 and section IX of the present disclosure, the method can include implementing a hybrid continuous variable-discrete variable (CV-DV) Quantum Key Distribution (QKD) network based on one or more entangled hybrid quantum states, where the one or more entangled hybrid quantum states are entangled based on mixing, using a beam splitter, a pair of idler photons output by a respective pair of single-photon addition modules each associated with an input quantum state of an entangled hybrid quantum state pair. This can further include generating an entangled DV-DV quantum state pair using a first beam splitter with inputs coupled to the respective outputs of a pair of single-photon addition modules, generating an entangled CV-CV quantum state pair using a second beam splitter with inputs coupled to the respective outputs of a second pair of single-photon addition modules, entangling the entangled DV-DV quantum state pair with the entangled CV-CV quantum state pair using a third beam splitter with inputs configured to receive a DV quantum state of the entangled DV-DV quantum state pair and a CV quantum state of the entangled CV-CV quantum state pair, and performing hybrid CV-DV QKD based on first and second entangled CV-DV pairs generated from the entangled DV-DV quantum state pair and entangled CV-CV quantum state pair.

### XII. Quantum Internet Enabled by Proposed Hybrid CV-DV Concepts

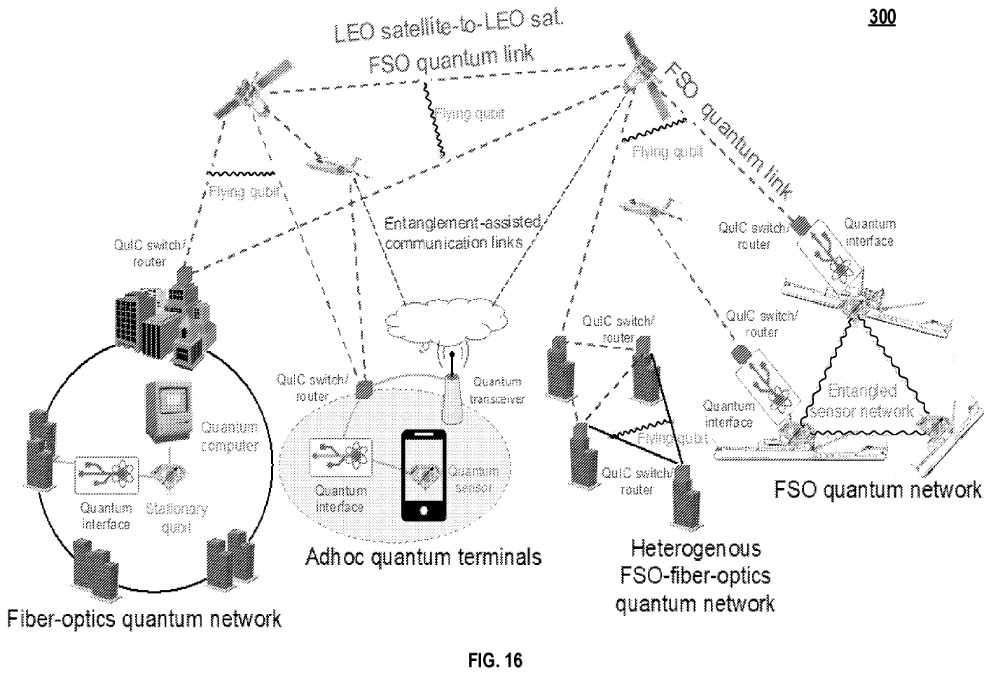

FIG. 16 illustrates a hybrid CV-DV quantum network architecture 300 suitable for long-distance distribution of entanglement among multiple quantum nodes. The hybrid CV-DV quantum network architecture 300 is empowered by hybrid CV-DV quantum interconnects, including quantum switches and routers, transceivers, interfaces, and memories. Various components of the hybrid CV-DV quantum network architecture 300 can include one or more processors in communication with one or more memories, where the entanglement-assisted communication protocols described herein can be encoded within the one or more memories as instructions and executable by the one or more processors. As such, when the instructions are executed by the one or more processors, the components of the hybrid CV-DV quantum network architecture 300 can communicate with one another in an entanglement-assisted manner. The hybrid CV-DV quantum communication network can give rise to new capabilities such as entanglement-assisted communication networks, entangled sensor networks, and distributed quantum computers.

To extend the distance between two remote quantum computers/nodes the quantum information to be exchanged is encoded using entangled hybrid CV-DV quantum states. In particular, communication between devices (e.g., quantum computers) of the various sub-networks can be implemented through entanglement-assisted communication protocols described herein. To implement such a quantum Internet infrastructure, quantum links including various quantum interconnects (QuICs) and quantum interfaces are needed. The quantum links could be heterogenous in nature, and can include but are not limited to fiber-optics links, free space optics (FSO) links, and low earth orbit (LEO) satellite links. In the example shown, the hybrid CV-DV quantum network architecture 300 includes various sub-networks including a fiber-optic quantum network, adhoc quantum terminals that include quantum sensors, a heterogeneous FSO-fiber-optic quantum network, and an FSO quantum network which can include an entangled sensor network. Further, communication links between sub-networks can be entanglement-assisted. The quantum communication network (QCN) can be defined as a system of quantum nodes in which an uninterrupted quantum channel can be established between any two nodes. When the quantum nodes are equipped with devices such as quantum computers, capable of exchanging the qubits (or qudits) over the QCN by teleportation, the corresponding QCN is commonly referred to as the quantum Internet.

To interconnect and entangle distributed quantum information processing devices, stationary quantum information must be retrieved, on demand, from quantum memories of a quantum computer and converted into flying (mobile) quantum information (flying qubits) by hybrid CV-DV QuIC modules (e.g., at the “transmitting” end). Photonic quantum information (flying qubits) is then transmitted to the destination through various genres of QuIC modules via heterogeneous fibers, ground-to-satellite (e.g., LEO satellite links), and FSO links by employing hybrid CV-DV entangled states. Transmission between sub-networks and devices within the sub-networks can be managed through QuIC switches/routers and quantum transceivers configured to interpret entanglement-assisted communication data. Another QuIC CV-DV module (e.g., at the “receiving end”) then converts back the received flying quantum information to stationary quantum information for local processing. In such a way, the quantum light path is established between two remote quantum computers. Therefore it can be concluded that the quantum CV-DV interface can be defined as a quantum module or subsystem allowing connection of the stationary and flying CV-DV qubits in order to establish a quantum channel between any two remote quantum nodes. By employing CV-DV entangled states to exchange quantum information between two remote quantum computers, quantum exchange rate and distance between remote quantum computers can be increased.

The foregoing description has been directed to specific examples. It will be apparent, however, that other variations and modifications may be made to the described examples, with the attainment of some or all of their advantages. For instance, it is expressly contemplated that at least some of the components, operations, and/or elements described herein can be implemented as software being stored on a tangible (non-transitory) computer-readable medium, devices, and memories (e.g., disks/CDs/RAM/EEPROM/etc.) having program instructions executing on a computer, hardware, firmware, or a combination thereof. Further, methods describing the various functions and techniques described herein can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on. In addition, devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example. Instructions, media for conveying such instructions, computing resources for executing them, and other structures for supporting such computing resources are means for providing the functions described in these disclosures. Accordingly, this description is to be taken only by way of example and not to otherwise limit the scope of the examples herein. Therefore, it is the object of the appended claims to cover all such variations and modifications as come within the true spirit and scope of the examples herein.

The description of the disclosure is provided to enable a person skilled in the art to make or use the disclosure. Various modifications to the disclosure will be readily apparent to those skilled in the art, and the generic principles defined herein may be applied to other variations without departing from the spirit or scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein. Illustrative aspects of this disclosure include:

Statement 1. A method that includes operations for hybrid CV-DV quantum communications and quantum networks. The operations include obtaining a first quantum state; obtaining a second quantum state; providing the first quantum state to a first single-photon addition module, wherein the first single-photon addition module generates as output a first idler state and a first photon addition signal state; providing the second quantum state to a second single-photon addition module, wherein the second single-photon addition module generates as output a second idler state and a second photon addition signal state; and mixing, using a beam splitter associated with a pair of outputs respectively connected to upper and lower branch single photon detectors (SPDs), an input including: a first idler photon associated with the first idler state generated by the first single-photon addition module; and a second idler photon associated with the second idler state generated by the second single-photon addition module.

Statement 2. The method of statement 1, further comprising: detecting a photon on either the upper branch SPD or the lower branch SPD; wherein the first quantum state and the second quantum state are entangled based on an uncertainty associated with the detected photon being associated with either the first idler state or the second idler state.

Statement 3. The method of any one of statements 1-2, wherein the first quantum state and the second quantum state include one or more of a discrete-variable (DV) quantum state, a continuous-variable (CV) quantum state, a hybrid CV-DV entangled quantum state, or a macroscopic quantum state.

Statement 4. The method any one of statements 1-3, wherein the first quantum state is independent from the second quantum state.

Statement 5. The method any one of statements 1-4, wherein the first and second single photon-addition modules, except the upper and lower branch SPDs and a pump diode, are integrated on a same chip.

Statement 6. The method of any one of statements 1-5, wherein the first quantum state is a first multipartite state and the second quantum state is a second multipartite quantum state.

Statement 7. The method of any one of statements 1-6, wherein providing the first multipartite state to the first single-photon addition module comprises: providing a last qubit of the first multipartite state to the first single-photon addition module.

Statement 8. The method of any one of statements 1-7, wherein providing the second multipartite state to the second single-photon addition module comprises: providing a first qubit of the second multipartite state to the second single-photon addition module.

Statement 9. The method of any one of statements 1-8, further comprising entangling the first multipartite state and the second multipartite state by interacting the first and second idler photons on the beam splitter, wherein detection of a photon on either the upper branch SPD or the lower branch SPD indicates that the multipartite states are entangled.

Statement 10. The method of any one of statements 1-9, further comprising performing entanglement swapping between a first entangled pair and a second entangled pair, wherein the first quantum state is included in the first entangled pair and the second quantum state is included in the second entangled pair.

Statement 11. An apparatus comprising a processor configured to execute one or more processes, and memory configured to store a process executable by the processor. The process, when executed, is operable to perform operations according to any of statements 1-10.

Statement 12. A non-transitory, computer-readable medium storing instructions encoded thereon. The instructions, when executed by one or more processors, cause the one or more processors to perform operations according to any of statements 1-10.

Additional aspects of this disclosure are set out in the independent claims and preferred features are set out in the dependent claims. Features of one aspect may be applied to each aspect alone or in combination with other aspects. In addition, while certain operations in the claims are provided in a particular order, it is appreciated that such order is not required unless the context otherwise indicates.

What is claimed is:

1. A method comprising:
obtaining a first quantum state;
obtaining a second quantum state;
providing the first quantum state to a first single-photon addition module, wherein the first single-photon addition module generates as output a first idler state and a first photon addition signal state;
providing the second quantum state to a second single-photon addition module, wherein the second single-photon addition module generates as output a second idler state and a second photon addition signal state; and
mixing, using a beam splitter associated with a pair of outputs respectively connected to upper and lower branch single photon detectors (SPDs), an input including:
a first idler photon associated with the first idler state generated by the first single-photon addition module; and
a second idler photon associated with the second idler state generated by the second single-photon addition module.

2. The method of claim 1, further comprising:
detecting a photon on either the upper branch SPD or the lower branch SPD;
wherein the first quantum state and the second quantum state are entangled based on an uncertainty associated with the detected photon being associated with either the first idler state or the second idler state.

3. The method of claim 1, wherein:
the first quantum state and the second quantum state include one or more of a discrete-variable (DV) quantum state, a continuous-variable (CV) quantum state, a hybrid CV-DV entangled quantum state, or a macroscopic quantum state.

4. The method of claim 1, wherein the first quantum state is independent from the second quantum state.

5. The method of claim 1, wherein the first and second single photon-addition modules, except the upper and lower branch SPDs and a pump diode, are integrated on a same chip.

6. The method of claim 1, wherein the first quantum state is a first multipartite state and the second quantum state is a second multipartite quantum state.

7. The method of claim 6, wherein providing the first multipartite state to the first single-photon addition module comprises:
providing a last qubit of the first multipartite state to the first single-photon addition module.

8. The method of claim 7, wherein providing the second multipartite state to the second single-photon addition module comprises:
providing a first qubit of the second multipartite state to the second single-photon addition module.

9. The method of claim 8, further comprising:
entangling the first multipartite state and the second multipartite state by interacting the first and second idler photons on the beam splitter, wherein detection of a photon on either the upper branch SPD or the lower branch SPD indicates that the multipartite states are entangled.

10. The method of claim 2, further comprising:
performing entanglement swapping between a first entangled pair and a second entangled pair, wherein the first quantum state is included in the first entangled pair and the second quantum state is included in the second entangled pair.

11. The method of claim 10, further comprising:
entangling an additional quantum state included in the first entangled pair with an additional quantum state included in the second entangled pair, based on interacting the first and second idler photons on the beam splitter, wherein detection of a photon on either the upper branch SPD or the lower branch SPD indicates that the first entangled pair is entangled with the second entangled pair.

12. The method of claim 2, further comprising:
providing a discrete-variable (DV) quantum state of an entangled DV-DV quantum state pair to a first photon-subtraction module, wherein the first photon-subtraction module generates as output a first subtracted photon and a first single photon state;
providing a DV quantum state of a hybrid entangled continuous variable-discrete variable (CV-DV) quantum state pair to a second photon-subtraction module, wherein the second photon-subtraction module generates as output a second subtracted photon and a second single photon state;
mixing, using an additional beam splitter having a pair of outputs respectively connected to additional upper and lower branch SPDs, the first single photon state generated by the first photon-subtraction module and the second single photon state generated by the second photon-subtraction module; and
detecting a photon on either the additional upper branch SPD or the additional lower branch SPD, wherein a remaining DV quantum state of the DV-DV quantum state pair is entangled with the CV quantum state of the hybrid CV-DV quantum state pair based on an uncertainty in the detected photon being associated with either the first single photon state or the second single photon state.

13. The method of claim 2, wherein the first quantum state and the second quantum state both comprise macroscopic continuous variable (CV) light states and are mixed using the beam splitter to generate an entangled CV-CV macroscopic state.

14. The method of claim 13, further comprising:
applying a phase shift to either the beam splitter input of the first idler photon or the beam splitter input of the second idler photon;
wherein the phase shift is selected such that the output macroscopic CV states are entangled.

15. The method of claim 2, further comprising performing noiseless amplification by providing an arbitrary state as input to a photon amplifier, wherein:
the photon amplifier includes a photon addition stage coupled to a photon subtraction stage, wherein an output of the photon addition stage is coupled to an input of the photon subtraction stage; and
the input state to the photon amplifier is provided in a superposition state that causes the photon amplifier to apply a noise-free gain.

16. The method of claim 1, further comprising:
obtaining, at a first node of a Quantum Communication Network (QCN), an input quantum information state comprising one or more qubits;
generating, by the first QCN node, a quantum low-density parity-check (QLDPC) codeword based on the input quantum information state, wherein the first QCN node generates the QLDPC codeword by encoding the input quantum information state using a QLDPC code; and
transmitting the QLDPC codeword from the first QCN node to an intermediate QCN node, wherein the first QCN node and the intermediate QCN node are included in a Quantum Error Correction (QEC)-based QCN.

17. The method of claim 16, further comprising:
receiving, at the intermediate QCN node, the QLDPC codeword transmitted from the first QCN node;
correcting, at the intermediate QCN node, a most probable quantum error operator identified by the intermediate QCN node; and
re-encoding, at the intermediate QCN node, the error-corrected QLDPC codeword, wherein the intermediate QCN node inserts one or more additional redundant qubits in the re-encoded QLDPC codeword;
wherein soft-decision decoding is performed at a final QCN node of the QCN.

18. The method of claim 3, wherein:
the first and second quantum states are both obtained cluster states associated with nodes of a Quantum Communication Network (QCN), wherein the QCN includes a plurality of nodes arranged in a 2D cluster state; and
the plurality of nodes arranged in the 2D cluster state of the QCN are entangled based on performing delocalized photon addition between one or more pairs of nodes.

19. The method of claim 1, further comprising implementing a hybrid continuous variable-discrete variable (CV-DV) Quantum Key Distribution (QKD) network based on one or more entangled hybrid quantum states, wherein the one or more entangled hybrid quantum states are entangled based on mixing, using a beam splitter, a pair of idler photons output by a respective pair of single-photon addition modules each associated with an input quantum state of an entangled hybrid quantum state pair.

20. The method of claim 19, further comprising:
generating an entangled DV-DV quantum state pair using a first beam splitter with inputs coupled to the respective outputs of a pair of single-photon addition modules;
generating an entangled CV-CV quantum state pair using a second beam splitter with inputs coupled to the respective outputs of a second pair of single-photon addition modules;
entangling the entangled DV-DV quantum state pair with the entangled CV-CV quantum state pair using a third beam splitter with inputs configured to receive a DV quantum state of the entangled DV-DV quantum state pair and a CV quantum state of the entangled CV-CV quantum state pair; and
performing hybrid CV-DV QKD based on first and second entangled CV-DV pairs generated from the entangled DV-DV quantum state pair and entangled CV-CV quantum state pair.
